(19) United States
(12) Patent Application Publication
(10) Pub. No.: US 2012/0244320 A1
(43) Pub. Date: Sep. 27, 2012

(54) FIBROUS PRODUCT, EMBOSSING ROLL FOR PRODUCING SUCH FIBROUS PRODUCT, AND DEVICE AND METHOD FOR PRODUCING SUCH FIBROUS PRODUCT

(75) Inventors: Jürgen Sauter, Mannheim (DE); Philippe Albouze, Aveze (FR)

(73) Assignee: SCA HYGIENE PRODCUTS AB, Goteborg (SE)

(21) Appl. No.: 13/514,079

(22) PCT Filed: Dec. 7, 2009
(86) PCT No.: PCT/EP2009/066511

§ 371 Date: Jun. 6, 2012

(51) Int. Cl. B32B 3/30; B29C 59/02

(52) U.S. Cl. 428/156; 425/385; 264/293

(57) ABSTRACT

A fibrous product, especially tissue paper product, non-woven product, or a hybrid thereof, especially hygiene and cleaning product, has at least one ply, the surface of which is partly covered with an embossing pattern. The pattern includes at least one first zone being micro-embossed with at least 30 embossing depressions per cm², preferably 30 to 160 embossing depressions/cm², more preferably 30 to 120 embossing depressions/cm², and most preferably 45 to 100 depressions/cm², forming a background embossing area. A plurality of second zones are unembossed and form a motif element. In addition to the second zones, at least one third zone is largely surrounded by linear depressions. Also disclosed is an embossing roll and an embossing device including a method for manufacturing such fibrous products.

### CROSS-REFERENCE TO PRIOR APPLICATION

This application is a §371 National Stage Application of PCT International Application No. PCT/EP2009/066511 filed Dec. 7, 2009, which is incorporated herein in its entirety.

### TECHNICAL FIELD

The disclosure relates to a fibrous product, especially tissue paper product, non-woven product or a hybrid thereof, and especially hygiene and cleaning product with at least one ply, the surface of which is partly covered with an embossing pattern. The disclosure also relates to an embossing roll for producing such a fibrous product and to a device and method for producing such fibrous products.

### BACKGROUND

Hygiene or wiping products primarily include all kinds of dry-creped tissue paper, wet-creped paper, TAD-paper (Through Air Drying) paper manufactured by the UCTAD process (Uncreped TAD), by the Atmos process (Voith) or by the NTT process (Metso) and cellulose or pulp-wadding or all kinds of non-wovens, or combinations, laminates or mixtures thereof. Typical properties of these hygiene and wiping products include the reliability to absorb tensile stress energy, their drapability, good textile-like flexibility, properties which are frequently referred to as bulk softness, a higher surface softness and a high specific volume with a perceptible thickness. A liquid absorbency as high as possible and, depending on the application, a suitable wet and dry strength as well as an appealable visual appearance of the outer product's surface are desired. These properties, among others, allow these hygiene and wiping products to be used, for example, as cleaning wipes such as paper or non-woven wipes, windscreen cleaning wipes, industrial wipes, kitchen paper or the like; as sanitary products such as for example bathroom tissue, paper or non-woven handkerchiefs, household towels, towels and the like; as cosmetic wipes such as, for example, facials and as serviettes or napkins, just to mention some of the products that can be used. Furthermore, the hygiene and wiping products can be dry, moist, wet, printed or pretreated in any manner. In addition, the hygiene and wiping products may be folded, interleaved or individually placed, stacked or rolled, connected or not, in any suitable manner.

Due to the above description, the products can be used for personal and household use as well as commercial and industrial use. They are adapted to absorb fluids, remove dust, for decorative purposes, for wrapping, or even just as supporting material, as is common, for example, in medical practices or in hospitals.

If tissue paper is to be made out of pulp, the process essentially includes a forming that includes a box and a forming wire portion, and a drying portion (e.g. through air drying or conventional drying on a yankee cylinder). The production process also usually includes the crepe process essential for tissues and, finally, typically a monitoring and winding area.

Paper can be formed by placing the fibers, in an oriented or random manner, on one or between two continuously revolving wires of a paper making machine while simultaneously removing the main quantity of water of dilution until dry-solids contents of usually between 12 and 35% are obtained.

Drying the formed primary fibrous web occurs in one or more steps by mechanical and thermal means until a final dry-solids content of usually about 93 to 97% has been reached. In case of tissue making, this stage is often followed by the crepe process which crucially influences the properties of the finished tissue product in conventional processes. The conventional dry crepe process involves creping on a usually 4.0 to 6.5 m diameter drying cylinder, the so-called yankee cylinder, by means of a crepe doctor with the aforementioned final dry-solids content of the raw tissue paper. Wet creping can be used as well, if lower demands are made of the tissue quality. The creped, finally dry raw tissue paper, the so-called base tissue, is then available for further processing into the paper product for a tissue paper product.

Instead of the conventional tissue making process described above, the use of a modified technique is possible in which an improvement in specific volume is achieved by a special kind of drying which leads to an improvement in the bulk softness of the tissue paper. This process, which exists in a variety of subtypes, is termed the TAD (Through Air Drying) technique. It is characterized by the fact that the “primary” fibrous web that leaves the forming and sheet making stage is pre-dried to a dry-solids content of about 80% before final contact drying on the yankee cylinder by blowing hot air through the fibrous web. The fibrous web is supported by an air-permeable wire or belt or TAD-fabric and during its transport is guided over the surface of an air-permeable rotating cylinder drum, the so-called TAD-cylinder. Structuring the supporting wire or belt makes it possible to produce any pattern of compressed zones broken up by deformation in the moist state, also named moulding, resulting in increased mean specific volumes and consequently leading to an increase of bulk softness without decisively decreasing the strength of the fibrous web.

To produce multi-ply tissue paper products, such as handkerchiefs, bathroom paper, towels or household towels, an intermediate step often occurs with so-called doubling in which the base tissue in the desired number of plies is usually gathered on a common multi-ply mother reel.

The processing steps from the base tissue that has already been optionally wound up in several plies are used in processing machines (converting machines) which include operations such as unwinding the base tissue, repeated smoothing of the tissue, printing, embossing, to an extent combined with full area and/or local application of adhesive to produce ply adhesion of the individual plies to be combined together as well as longitudinal cut, folding, cross cut, placement and bringing together a plurality of individual tissues and their packaging as well as bringing them together to form larger surrounding packaging or bundles. Such processing steps may also include application of substances like scents, lotions, softeners or other chemical additives. The individual paper ply webs can also be pre-embossed and then combined in a nip of rolls according to the embossing methods known in the art. Any embossing can lead to embossed elements all having the same height or to embossing elements having different heights. Ply bonding, e.g. by mechanical or by chemical means are other well-known methods mainly used for hankies, napkins and bathroom tissues and household towels.

The term “embossing” is not restricted to a process of mechanically amending the physical structure of a tissue paper in the converting part of tissue manufacturing. The term “embossing” also includes any amendments of the physical structure of a base tissue paper in the forming or drying part of tissue manufacturing by using structurized sieves, or fabrics, of felts, or belts, or blades (e.g. in line with the Atmos-process, the NTT-process or the CPN-process).

A known technique to increase the thickness of a paper product is to emboss the paper web. An embossing process may be carried out in the nip between an embossing roll and an anvil roll. The embossing roll can have protrusions on its circumferential surface leading to so-called embossed depressions in the paper web or it can have depressions in its circumferential surface leading to so-called embossed protrusions in the paper web.

Anvil rolls may be softer than the corresponding embossing roll and may include rubber, such as natural rubber, or plastic materials, paper or steel.

For manufacturing multi-ply tissue products, especially bathroom tissue and household tissue, three main manufacturing methods for embossing and adhesively bonding of the plies have been established. These are Goffra Incolla/spot embossing, DESL (Double Embossing Single Lamination)/Nested, and Pin-to-Pin/Foot-to-Foot. Other methods for manufacturing multi-ply tissue products are based on a mechanical ply-bonding process without using adhesives, e.g. by mechanical compression of the plies. Before ply-bonding the plies are often embossed in nips of an embossing roll and an anvil roll.

In the first mentioned manufacturing method, Goffra Incolla, a first web is directed through the nip between an embossing roll and an anvil roll. In this nip, the web is provided with an embossing pattern. Thereafter, an application roll applies adhesive to those parts of the first web at which there are protruding embossing elements in the embossing roll. The adhesive is transported from an adhesive bath via an adhesive transfer roll to the application roll. A second web is transported to the first web and adhesively bonded to the first web in the nip between the so-called marrying roll and the embossing roll. The adhesive bonding takes place at those portions at which the adhesive was applied.

The second manufacturing method (DESL/Nested) is very similar to the above-described Goffra Incolla method. It includes an additional pair of rolls including a second embossing roll and a second anvil roll. The additional pair of rolls serves to emboss the second web before it is adhesively bonded to the first web using the marrying roll. Typically, the additional pair of rolls is placed close to the first pair of rolls and the marrying roll. Especially when using the so-called Nested-method such close arrangement is important. The Nested-method can be considered as a special case of the general DESL-manufacturing method. For the Nested-method the embossing elements of the first embossing roll and the embossing elements of the second embossing roll are arranged such that the embossed elements of the first embossed ply and the embossed elements of the second embossed ply fit into each other similar to a gearing system. This serves to achieve a mutual stabilization of the two plies. However, for the DESL manufacturing method such correlation between the embossed elements of the first, upper ply and the second, lower ply, does not have to apply. Nevertheless, in a literature the term DESL is often used synonymous to a Nested-method.

The third manufacturing method (Pin-to-Pin/Foot-to-Foot) is similar to the DESL method. By means of two pairs of rolls both the upper ply and the lower ply are embossed, respectively. Adhesive is applied onto the embossed protrusions of the first ply. The ply bonding however, is not achieved by means of a marrying roll as in the DESL method but is achieved directly by means of the protruding embossing elements of the second embossing roll. In order to achieve this, an exact adjustment of the width of the gap between the first embossing roll and the second embossing roll is required, which is mainly defined by the individual thickness of both webs (upper ply and lower ply). Further, the embossing rolls have to be designed such that at least some of the protruding embossing elements of both rolls face each other. This is the reason why the terminology Pin-to-Pin or Foot-to-Foot embossing is used.

All above described methods have the following common features: the first embossing roll is formed of a hard material, usually metal, especially steel, but there are also known embossing rolls made of hard rubber or hard plastics materials. The embossing rolls can be a male roll having individual protrusions. Alternatively, the embossing roll can be a female roll with individual embossing depressions.

The anvil roll typically has a rubber coating. However, structurized anvil rolls, especially rolls made of paper, rubber or plastics materials or steel are also known.

The applicator roll for adhesive is usually also a rubber roll with a plain smooth circumferential surface, wherein the hardness of the rubber coating is between the hardness of the anvil roll and the hardness of the marrying roll. Commonly used values for the hardness of the rubber coating are 70 to 85 Shore A. When selecting the rubber material its compatibility with the adhesive to be applied has to be ensured.

The application system for adhesive consisting of applicator roll, adhesive transfer roll and adhesive bath can be designed as a so-called immersion roll system in which the adhesive transfer roll is immersed into the adhesive bath and transports adhesive by means of surface tension and adhesive forces out of the adhesive bath. By adjusting the gap between the adhesive transfer roll and the applicator or application roll, the amount of adhesive to be applied can be adjusted. Application rolls may be structured rolls. Further, adhesive transfer rolls have become known having defined pit-shaped depressions in their circumferential surface. Such adhesive transfer rolls are known as anilox-rolls. Such a roll is usually made of ceramic material or it is a roll made of steel or copper and coated with chromium. Excessive adhesive is removed from the surface of the anilox-roll by means of a blade. The amount of adhesive is determined by the volume and the number of depressions. Alternative application systems for applying adhesives are based on a spraying equipment (e.g. Weko-technique).

A second possibility to influence the amount of adhesive transferred is the adjustment of the difference in circumferential speeds of the adhesive transfer roll and the applicator roll. Typically, the adhesive transfer roll rotates slower than the applicator roll. The circumferential speed of the adhesive transfer roll is usually between 5% and 100% of the first circumferential speed of the applicator roll. The adhesive bath can be designed as a simple trough, application systems with a blade can also be designed as chamber systems.

The embossing technologies Goffra Incolla/spot embossing and DESL/Nested, both use an additional roll, the so-called marrying roll for laminating together the plies. The marrying roll commonly has a smooth rubber surface with a hardness of about 90-95 Shore A. A suitable material is e.g. NBR (acrylnitrile-butadien rubber). However, marrying rolls also have become known which, in addition to the rubber coating, are provided with a steel coating. Such steel coating is often provided in form of a steel band spirally wound onto the rubber coating as described in WO2004/065113.

In case that the single plies individually or together are pre-embossed, a so-called micro-pre-embossing device is used. Such pre-embossing device is often used in combination with the Goffra Incolla technology. Also commonly used is a printing onto the tissue product before or after the ply bonding step. Also known are variants including the application of chemical substances, especially lotions and softeners.

Another well-known embossing technique comprises a steel embossing roll and a corresponding anvil steel roll (so-called Union embossing). The surfaces of these rolls are being formed in such a manner that deformation of the paper and mechanical ply bonding without using adhesives are achieved within one single embossing step.

When using one of the above described three embossing methods also for a pin-to-pin technique it is advantageous to provide a control for the tension of the web both before and after the ply bonding because the physical properties of the web and especially the stress-strain characteristic can be changed significantly in the embossing step.

The embossing not only serves to provide bulk to the fibrous product but also to provide an improved optical appearance to the product. The optical appearance of a product is important for consumer products and also serves to provide a higher degree of recognition to the product. The optical appearance can be improved by combining embossing and coloring steps. Another reason for embossing is to generate higher absorbency or improved perceived softness.

In the prior art, different embossing techniques have been used to achieve a desired visual effect in embossing patterns. One possibility is to define specific regions in an embossed product in which the dot densities, i.e. the distances between individual, equidistantly arranged embossing spots are different to those of adjacent regions in order to generate a visual effect.

Another possibility to achieve a visual effect is to arrange individual embossing protrusions such that they form a linear pattern. An example for such linear alignment of individual embossing protrusions is disclosed in U.S. Pat. No. 6,520,330 B1. The embossing pattern shown therein is formed by identical embossing protrusions which have different distances to the neighboring embossing protrusions so that an optical appearance is created.

A further possibility is to create an optical appearance by selecting different sizes of embossing protrusions. Such patterns are shown in EP 1 253 242 A2 or EP 1 209 289 A1 also using the concept of aligning single embossing protrusions.

There are several options to provide good optical appearance of an embossed fibrous product. EP 1 047 546 B1 describes a product with a continuous background pattern of embossed depressions and with certain unembossed zones acting as motif elements. The visibility of such elements may be enhanced by providing linear arrangements of dot-like embossed depressions along the motifs.

A tissue paper product with separate micro-embossed regions and additional linear depressions showing motif elements are known from US 2007/0122595 A1. The linear depressions can either be provided within micro-embossed regions or fully outside the micro-embossed regions and within unembossed areas of the tissue paper product.

The motif elements according to DE 20 2006 009 274 U1 are formed by unembossed areas within an overall pattern of dot-like embossed depressions evenly distributed over the product.

The tissue product according to US 2006/0286885 A1 has an embossing pattern with motif elements surrounded by closed linear embossed depressions. Further, the embossed background pattern formed by dot-like micro-embossed depressions is interrupted by macro bosses defining stitch-like patterns to enhance the visual effect of the product.

### SUMMARY

It is desired to provide a fibrous product, an embossing roll, a device, and a method for producing such product so that the optical appearance and the perceived softness of the product can be improved.

This can be provided by a fibrous product with at least one ply, the surface of which is partly covered with an embossing pattern, wherein the pattern includes at least one first continuous zone being micro-embossed with at least 25 embossing depressions per cm², forming a background embossing area; a plurality of second zones being unembossed and forming at least one motif element; and at least one third zone being largely surrounded by linear depressions and an embossing roll for producing such a fibrous product. Also, an embossing device for manufacturing such a fibrous product and a method for manufacturing such a fibrous product.

The fibrous product can be especially a tissue paper product, non-woven product or a hybrid thereof, and in particular a hygiene and cleaning product. The fibrous product has at least one ply with a surface which is partly covered with an embossing embossed pattern and is characterized in that the pattern includes a first zone being micro-embossed with at least twenty-five embossing depressions per cm², forming a background embossing pattern, wherein the first zone is a continuous zone. The pattern further includes a plurality of second zones with no embossing depressions wherein the second zones form at least one motif element. Finally, the pattern includes in addition to the second zones at least one third zone being largely surrounded by linear depressions.

The term “surface” also includes a mechanical amendment of the physical structure of the tissue ply in the third dimension so that the depth of the tissue ply below the surface may also be influenced by an embossing step.

In other words, the embossed pattern includes three individual zones, wherein the second zones are not provided with embossing depressions. The reason why such second zones are still considered to be part of the embossed pattern lies in the fact that the second zones could be placed at some elevated or recessed level in order to increase the visibility of a motif element represented by the second zones. The first, micro-embossed zone largely determines the perceived bulk of the product. However, the first zone has a double function in that it surrounds the second zones whose outer shapes represent a specific motif element which can be recognized by the consumer. The second zones can also be used to add a technical effect to their visual appearance. Since the second zones have a flat and smooth surface, they contribute to high hand-feel values of the fibrous product. This is why the third zones must not fully lie within the second zones. The at least one third zone is largely surrounded by linear depressions which can be either continuous or non-continuous. Besides a marked optical effect of the third zones, they also have a double function in that they can be used to provide ply-bonding between the embossed ply and one or more further plies of a multi-ply product.

In particular embodiments, the micro-embossed first zone includes 30 to 160 embossing depressions/cm², especially by 30 to 120 embossing depressions/cm² and most particularly by 45 to 100 embossing depressions/cm². These embossing depressions form the background embossing area of the first zone.

Where the number of embossing depressions is less than 25 per cm² it can become difficult to clearly identify the motif of the second zone because the borders between the different zones will become less accurate. If the number of embossing depressions exceeds 160 per cm² a single embossing depression will become very small and flat and cannot be clearly recognized as an individual embossing depression. Due to this fact it will become difficult for the consumer to clearly distinguish between the first and the second zone if the number of embossing depressions exceeds 160 per cm². Moreover, such a high number of embossing depressions in the first zone can result in a decrease of bulk of the final fibrous product and in a loss of its absorption properties.

In certain embodiments, the design of the second zones and the at least one third zone are similar or identical which means that the motif element represented by the second zones thematically corresponds to the motif element formed by the linear depressions of the at least one third zone.

In order to improve the optical effect of the second zones, some specific measures can be taken either separately or in combination. In the one hand, the visual appearance of the second zones can be improved by using dry-creped paper which is as flat as possible. If a paper produced by a TAD-process is used, the material is much more uneven so that the contrast between the second zones and the micro-embossed impressions of the background pattern of the first zone is smaller. As a result of this, the visibility of the motif elements of the second zones is inferior. A second measure is to adjust the embossing depressions of the first zone such that some of these depressions closely surround and follow the desired contour of the second zones. This can be either achieved by deviating from a fixed arrangement pattern of the micro-embossed depressions. Such micro-embossed depressions can be placed so that one or more lines of micro-embossed depressions fully surround the second zones. A second option is to provide a fixed arrangement of the micro-embossed depression but to provide a sharper and less blurred motif element of the second zones by providing only parts of the micro-embossed depressions along the edges of the second zones. The visual effect is similar to cutting a motif out of a sheet with a fixed raster. This will also lead to certain raster points being suitably cut in order to more accurately follow the desired contour of the motif element.

Further, it is possible to surround the second zones by macro-embossing depressions which are bigger than the micro-embossing depressions.

Another possible means to increase the overall visibility of the motif elements is to leave out a margin around the linear depressions around the third zones.

A further means to improve the optical appearance of the overall fibrous product is to position the embossed depressions of the background embossed area so as to form an optically appealing background pattern. Such background pattern can also thematically relate to the motif of the third zones. To give an easy example, the background embossed pattern can form waves which thematically fit to maritime motifs of the second zones and third zones. Alternatively, the embossed depressions can be rastered in such a way as to form an overall motif element wherein higher dot densities or dot sizes of the embossed depressions represent darker areas of a black and white greyscale motif picture.

The term non-woven according to ISO 9092, DIN EN 29092 is applied to a wide range of products which, in terms of their properties are located between those of paper (DIN 6730, May 1996) and cardboard (DIN 6730) on the one hand, and textiles on the other hand. As regards non-woven, a large number of extremely varied production processes are used, such as the air-laid and spun-laced techniques as well as the wet-laid techniques. The non-wovens include mats, non-woven fabrics and finished products made thereof. Non-wovens may also be called textile-like composite materials, which represent flexible porous fabrics that are not produced via the classic methods of weaving warp and weft or by looping. In fact, non-wovens are produced by intertwining, cohesive or adhesive bonding of fibers, or a combination thereof. The non-woven material can be formed of natural fibers, such as cellulose or cotton fibers, but can also include synthetic fibers such as polyethylene (PE), polypropylene (PP), polyurethane (PU), polyester, fibers on the basis of polyethylenterephtalate, polyvinyl alcohol, nylon or regenerated cellulose or a mix of different fibers. The fibers may, for example, be present in the form of endless fibers or pre-fabricated fibers of a finite length, as synthetic fibers, or in the form of staple fibers. The non-wovens as mentioned herein may thus include mixtures of synthetic and cellulose fibrous material, e.g. natural vegetable fibers (see ISO 9092, DIN EN 29092).

The term “hygiene products” and “cleaning products” as used herein include bathroom tissue, household towels, handkerchiefs, facial tissues, napkins, wiping and cleaning products as well as table ware.

According to a certain embodiment, at least some of the second zones abut the first zone. In other words, such second zones are not surrounded by continuous or non-continuous lines but formed directly within the background pattern of the first zone. In particular embodiments, all third zones and second zones are arranged such that the second zones and third zones are isolated from each other. This means that there is no overlap on the surface of the fibrous product of the second zones and third zones. In the description below, both an example of isolated second zones and third zones and of partially overlapping second zones and third zones will be given in order to more clearly point out the optical appearance of second zones and third zones isolated from each other. Correspondingly, another particular embodiment is characterized in that at least one second zone, or in particular all second zones, and the at least one third zone are arranged such that second zones and third zones partly overlap with each other. However, a full overlap of the second zones and third zones has to be avoided because otherwise the second, unembossed zones are likely to be misinterpreted as the background surface of the third zones without realizing that the second zones independently represent a motif element. Further, the technical effect of the second zones gets lost.

In certain embodiments, the at least one second zone has a size of at least 0.5 cm², preferably at least 1 cm², more preferably at least 2 cm² and most preferably between about 3 cm² and about 5 cm², and the at least one third zone has a size of at least 0.2 cm², preferably at least 0.5 cm², more preferably at least 1 cm² and most preferably between about 2 cm² and about 5 cm². Such ranges provide a good visibility of the motif elements without being too large which can be detrimental to the physical properties of the fibrous product.

According to a certain embodiment, the total area of all first zones covers 25 to 90% of the total surface of one side of the product, wherein the total area of all second zones covers 5 to 70%, and the total area of all third zones covers 5 to 30% of the total surface of the side of the product. In more certain embodiments, the total area of all first zones covers 35 to 80%, especially 40 to 70% of the total surface of one side of the product, wherein the total area of all second zones covers 10 to 50%, especially 15 to 35%, and the total area of all third zones covers 10 to 25%, especially 15 to 25% of the total surface of the side of the product. Such ranges do not only serve to provide good visibility of the motif elements but also to make sure that the desired physical properties of the fibrous product are achieved. If ply bonding is effected along the linear depressions of the third zones, a total area of such third zones surrounded by the linear depressions should not be too high so that the product is still soft. The coverage of the first zones should not be too small because the embossed background pattern gives the fibrous product a higher perceived volume, as was outlined in more detail above. Also the overall coverage of the second zones should not be above 70% because such unembossed areas are smooth and lead to high hand-feel values but, at the same time, would reduce the perceived softness and bulk of the product. Further, a total surface coverage of all second zones which is too low has a negative effect on the visibility of the motif elements of the second zones.

The fibrous product may include, besides these three zones, fourth zones, fifth zones or even more zones. Such additional zones are e.g. characterized by a plurality of different heights or by a three-dimensional embossing structure (WO2009/010092) and can be, in particular, isolated from each other.

According to a certain embodiment, the product includes at least two plies bonded together, wherein ply bonding is especially effected by adhesive, more particularly colored adhesive, and wherein the ply can be bonded together at least partly along the linear depressions of the at least one third zone.

Reference to at least one ply indicates that the fibrous product can be a single-ply or multi-ply product. Besides the at least one top ply as discussed above, there can be additionally one or a plurality of backside plies. Further, two or more top plies with a partly embossed pattern can be embossed together.

The backside ply or backside plies can have the same embossing pattern as the top ply or plies, or can be the mirror image of the top ply. The definition of which of the plies is the top ply and which is the backside ply is then arbitrary. In the other cases in which the backside ply does not have the specific arrangement of the embossing depressions forming first, second and third zones, the first ply is then the one according to the particular embodiments of the invention.

Additionally, the product can also have one or more middle plies non-embossed or embossed separately from the first ply or plies and the backside ply or plies. As a further alternative, the multi-ply fibrous product could include at least one middle ply which is volume embossed. The technique of volume embossing conventional products is known from WO2002/103112, the teaching of which is incorporated herein by reference. A volume embossed middle ply serves to impart a high volume to the product and might be used if a product is desired with the feeling of high volume.

The ply bonding can be carried out by adhesive. Another possibility to achieve ply bonding is mechanical ply bonding, such as knurling which is usually performed along at least one longitudinal edge of the product. Likewise, edge embossing can be performed along all four sides of the product.

If the plies are bonded together by adhesive, a conventional application system like a so-called immersion-roll system can be used which was explained above. As regards the adhesive, also conventional adhesive mixtures either colored or not colored can be employed.

According to a particular embodiment, each ply has a basis weight of 10 to 40 g/m² and/or the fibrous product has total basis weight of 15 to 120 g/m².

In a certain embodiment, the fibrous product is made of creped tissue paper, especially of dry creped tissue paper which has a relatively smooth surface so that the motif elements represented by the second zones has a high visibility because of the high contrast between second zones and first zone or zones.

In a certain embodiment, the caliper per ply is at least 100 micrometers, preferably at least 120 micrometers and most preferably around 150 micrometers. Determining the caliper value is carried out in line with DIN EN 12625-3 at the final tissue product. Afterwards the caliper per ply is calculated by dividing the measured value by the numbers of plies.

In the fibrous product, the individual embossed depressions of the first zones can be dots having a cross-sectional shape which is essentially circular or essentially elliptical or oval or essentially square-shaped or essentially polygon and which are arranged regularly. However, the individual embossing depressions can be arranged in a random manner in order to produce an additional optical effect which can be either ornamental or represent more complex motifs by arranging the individual embossing depressions such as to represent a frequency modulated raster element.

The backside ply or backside plies can be embossed with a second embossing pattern different to the embossing pattern of the first ply or plies, the second embossing pattern can include a micro-embossing pattern. A micro-embossing pattern is a relatively regular pattern of densely arranged small embossed depressions having a density of embossed elements of at least 25/cm². Such a micro-embossing pattern of the backside ply or plies can be selected freely based on functional criteria in order to give the fibrous products certain characteristics in term of overall strength, bulk or smoothness.

The disclosure also relates to an embossing roll for producing fibrous products. The embossing roll has an embossing surface suitable to run against an anvil roll and is characterized in that the embossing surface includes at least one first zone being a micro-embossing zone with at least 25 micro-embossing protrusions per cm², the micro-embossing protrusions having a first height (H₁) over a base circumferential surface of the embossing roll. The embossing surface further includes a plurality of second zones with no embossing protrusions within the second zones, the second zones having a second height (H₂) over the base circumferential surface of the embossing roll. Finally, the embossing surface includes a plurality of third zones being provided by continuous or interrupted linear protrusions having a third height (H₃) over the base circumferential surface of the embossing roll. In particular embodiments, the third zones are essentially surrounded by the linear protrusions. Besides the three zones, the embossing roll may include fourth, fifth or even more zones. Such additional zones are e.g. characterized by a plurality of different heights or by a three-dimensional embossing structure.

In particular embodiments, the first height (H₁) is between 0.4 mm and 1.4 mm, the second height (H₂) is between 0 mm and 2.5 mm, and the third height (H₃) is between 0.8 mm and 2.5 mm. In other words, the second zones can have no elevation at all over the base circumferential surface so that the second zones lie in the base circumferential surface of the embossing roll. This corresponds to a product produced by such embossing roll in which the second zones are not recessed or elevated. Although a range is given for the first height and the third height which shows some overlap, it is preferred that the third height exceeds the first height in order to improve the visibility of the motif represented by the third zones.

In particular embodiments, the embossing roll is characterized by the fact that the third height (H₃) of the third zone should exceed the first height (H₁) of the first zone by at least 0.2 mm and not more than 1 mm and especially by at least 0.35 mm and not more than 0.6 mm. According to another embodiment, the embossing roll is characterized by a width of the line elements of the third zone of between 0.2 mm and 2.0 mm, especially of between 0.3 mm and 1.5 mm and most preferably of between 0.4 mm and 1.0 mm.

Moreover, such an embossing roll should have micro-embossing protrusions having a surface of between 0.02 mm² and 1.0 mm², especially of between 0.04 mm² and 0.5 mm².

The embossing device for manufacturing a fibrous product includes at least one embossing roll as described above and at least one counter roll (or anvil roll).

According to a certain embodiment, the embossing device includes a first embossing roll and a second embossing roll arranged downstream of the first embossing roll. The first embossing roll has at least one first zone on its circumferential embossing surface which is provided with micro-embossing protrusions having a density of at least 25 micro-embossing protrusions per cm², and a plurality of further zones with no embossing protrusions. The second embossing roll has a plurality of third zones on its circumferential embossing surface being provided with linear protrusions. The embossing protrusions of the second embossing roll can have a height exceeding the height of the embossing protrusions of the first embossing roll, especially by 0.4 mm.

In order to manufacture a product with a satisfactory optical appearance by means of such embossing devices with two embossing rolls, the two embossing rolls have to be in register so that the position of the third zones relative to the first and second zones is not arbitrary. The plurality of further zones of the first embossing roll with no embossing protrusions are the second zones as well as regions not covered with a micro-embossing pattern which, in the final product, represent the third zones and, where applicable, an unembossed margin around the linear depressions surrounding the third zones.

The embossing device as described above can further include a marrying roll. Such marrying roll runs against the second embossing roll for bonding together the at least one top ply and at least one further ply. Such marrying roll is used in the conventional Goffra Incolla type process or in a nested process. However, a marrying roll is not necessary in case of direct bonding together of two embossed plies using the above-described pin-to-pin ply bonding in which the tips of embossing patterns of two plies face each other and are laminated together at such tips. The device can include a further embossing roll running against the second anvil roll for embossing at least one further ply.

According to a particular embodiment, the embossing device further includes an application roll for applying adhesives. In particular embodiments, colored adhesive is used which can be selected in order to give a specific optical appearance to the product. The use of adhesives is another means to influence the technical properties of the combined product, especially during the ply-bonding process of the fibrous product. Selecting a useful adhesive may result in a fibrous product with a limited stiffness.

The method for manufacturing a fibrous product, especially tissue paper products, non-woven product or a hybrid thereof and especially hygiene and cleaning product with at least one ply, includes the steps of (a) embossing the at least one first zone, and (b) embossing the at least one third zone, wherein steps (a) and (b) are carried out either simultaneously by directing at least one ply into the nip between an embossing roll and a counter roll or anvil roll, or sequentially by directing the at least one ply through at least two subsequent embossing devices.

In certain embodiments, the method further includes the step of (c) calendering the second zones in step (a) and/or in step (b). The calendering of those parts of the fibrous product which form the second zones leads to an improved evenness of the surface which contributes to higher hand-feel values.

According to a certain embodiment, the method is characterized in that in a step (d) the at least one ply and a further ply are laminated at least partly at some of the lines of the third zones by applying adhesives to at least some of the linear protrusions of the at least one ply arranged over the surface of the embossing roll.

According to another embodiment, the method is characterized by a structurizing step of at least one ply in at least one manufacturing zone directly within the tissue making process, in particular, under wet conditions, and most particularly by using a structurized fabric or belt or felt or a combination of such structurized elements. The structurizing step can be carried out by using the Atmos process, NTT process or CNP process in the wet part or in the drying part of a papermaking machine.

For laminating together the single webs of material, different types of adhesive can be used. Suitable adhesives are, inter alia, glue on the basis of starch or modified starch like, for example, methyl cellulose or carboxylized methyl cellulose and adhesively acting polymers on the basis of synthetic resins, caoutchouc, polypropylene, polyisobutylene, polyurethane, polyacrylates, polyvinylacetat or polyvinyl alcohol. Such adhesives can also contain coloring agents in order to improve the optical appearance of the finished products. Frequently, water based glues are used for laminating together paper layers.

Another option to increase the visibility or to enhance the visual appearance of the product is to provide a multi-ply fibrous product which has at least one ply with a color that is different to the color of the other ply or plies. The provision of a selected ply having a different base color can provide interesting visual effects in combination with a first ply representing a motif element covering the motif surface area.

The fibrous product is characterized by ply-bonding at less points compared to the prior art resulting in an increased flexibility of the plies towards each other, and in a significantly enhanced softness perception. In addition, the fibrous product is further characterized by an improved visual appearance with line elements and dots compared to the prior art whereby missing dots products do not include line elements. Moreover, the fibrous product has a significantly increased bulk compared to prior art products.

### BRIEF DESCRIPTION OF THE DRAWINGS

In the following, embodiments of the invention will be briefly described with reference to the drawings, in which:

FIG. 1 shows a fibrous product according to a first embodiment;

FIGS. 2 and 3 show enlarged views of FIG. 1;

FIG. 4 shows a second embodiment;

FIGS. 5a to 5f show cross-sectional views of two embossing rolls and a two ply product produced by means of these two structurized embossing rolls in a pin-to-pin configuration;

FIGS. 6a to 6c show cross-sectional views of two embossing rolls and a two ply product produced with these two structurized embossing rolls in a nested configuration; and

FIGS. 7a to 7c show cross-sectional views of an embossing roll and a marrying roll, and a two ply product produced by means of the so-called Goffra Incolla method.

### DETAILED DESCRIPTION OF PREFERRED EMBODIMENTS

In the following description of preferred embodiments, the same basic elements will be denoted by the same reference numerals although, throughout different embodiments, specific details of the basic elements might differ.

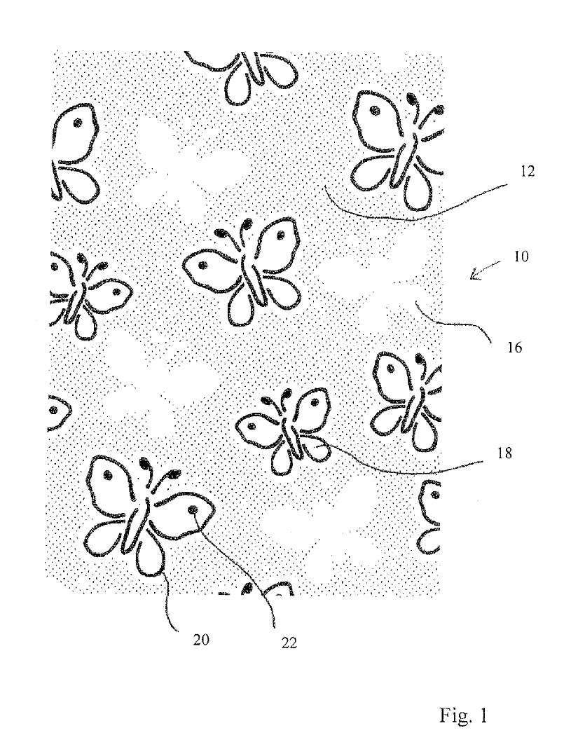

FIG. 1 shows a plan view on the main surface of the top ply of a fibrous product. The product might have an identical bottom ply so that, for the sake of simplicity, FIG. 1 is considered to be a view on the top ply of the product.

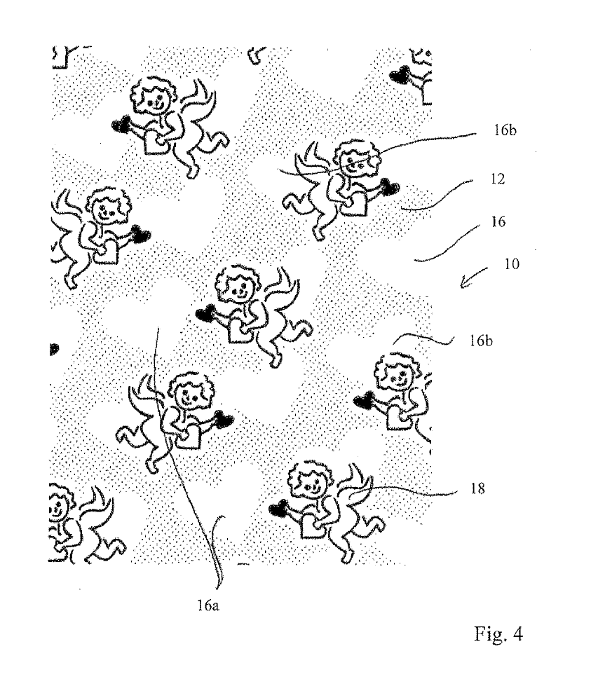

The ply 10 is partly embossed and different zones can be distinguished. Firstly, there is a continuous first zone 12 which is provided with a micro-embossing pattern. Micro-embossing means that the average density of the embossing depressions is relatively high and exceeds at least twenty-five embossing depressions per cm². The embossing depressions may have any suitable shape conventionally used for micro-embossed patterns. From the strongly enlarged detail as shown in FIG. 3 it follows that the embossing depressions 14 have a square shaped top surface and could have the shape of a truncated pyramid. The micro-embossing first zone determines some basic technical features of the product like the perceived volume or strength. In the example according to FIG. 1, the micro-embossing depressions 14 are regularly arranged throughout the first zone. Alternatively, such micro-embossing depressions could have an irregular arrangement which either stresses the shape of the unembossed zones or is selected so as to provide an esthetically appealing effect like undulated patterns or even rastered images which are generated by simulating grayscales of black and white image by adjusting the frequency of the micro-embossing depressions 14.

Besides the first zone 12, the product is also provided with a plurality of second zones 16 which are not embossed. The second zones 16 might lie on the same base surface as the first zone 12 or could be selectively arranged at an elevated or recessed level compared to the base surface of first zone 12. As can be seen from FIG. 1, the second zones 16 are shaped so as to show butterflies. It is important to note that the unembossed second zones 16 form motif patterns by their own. The second zones 16 can be relatively flat which improves the perceived hand-feel values of the product.

Finally, there is a plurality of third zones 18, which, as can be seen from FIG. 1, show butterflies of different sizes. The third zones 18 are also not provided with micro-embossing depressions and are additionally formed by a plurality of linear embossing depressions 20 which mainly surround the motif element formed by the third zones. Nevertheless, the specific example of FIG. 1 shows that the linear embossing depressions 20 do not necessarily have to surround only the motif elements. There are embossing depressions referenced to by numeral 22 which additionally provide an optically appealing effect and, from a technical point of view, can be preferably provided within bigger unembossed areas of the third zones in order to stabilize such areas against one or more backside plies not shown in FIG. 1.

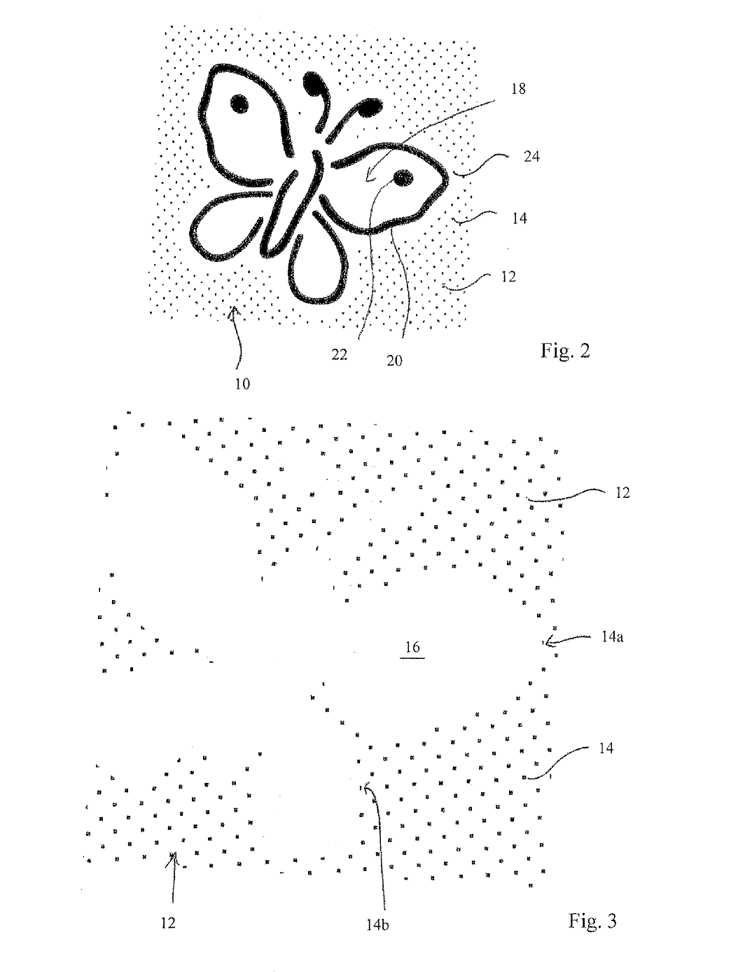

Further, it can be noted that the linear embossing depressions 20 of the third zones 18 are additionally surrounded by a margin 24 which can be best seen in FIG. 2 and which is not provided with micro-embossing depressions 14.

The linear embossing depressions 20 of the third zones can have different lengths and/or widths in order to further contribute to an optically appealing effect of the motif elements shown.

All or at least a considerable portion of the linear embossing depressions 20 serve to provide ply-bonding between the top ply of the product as shown in FIGS. 1, 2 and 3 and one or more backside plies.

Turning to FIG. 3, part of a second zone 16 of FIG. 1 and the surrounding first zone 12 are shown in an enlarged view. What is interesting to note is the fact that some of the micro-embossing depressions 14 like the example depressions 14a, 14b do not have their regular size but are cut such as to follow as closely as possible to the desired contour of the second zone 16. This serves to increase the sharp visibility of the second zones 16 relative to the first zone 12. The higher the dot density in the first zone 12 is, the less blurred are the motifs of the second zone. Further factors to increase the visibility of the second zone motif elements is the evenness of the surface of the second zones. To this end, dry creped tissue paper has shown to be especially advantageous to provide a high optical contrast between the second zones 16 and the surrounding first zone 12.

In order to increase the visibility of specific motif elements and to provide a strong optical impression, certain further measures can be taken. Firstly, it is possible also to provide linear embossing depressions within the first zone 12 to provide a further motif to be perceived by a user. Further, an irregular background pattern of the micro-embossing depressions 14 can be provided as was discussed in more detail above. Further, some of the micro-embossing depressions might be provided with colored substances which can be applied to the micro-embossing depressions if two separate embossing rolls are used and, in a first step, only the micro-embossing depressions are generated in a first embossing station. In such a case, ink or other colored substances can be selectively applied to the embossed surface in order to increase its visual effect. Finally, colored adhesive could be applied to the linear embossing depressions 20 in order to increase the visibility of these linear depressions.

In the embodiment of FIGS. 1 to 3, the motif elements of the second and third zones are identical and second and third zones are strictly separated from each other so there is no partial overlap between these zones.

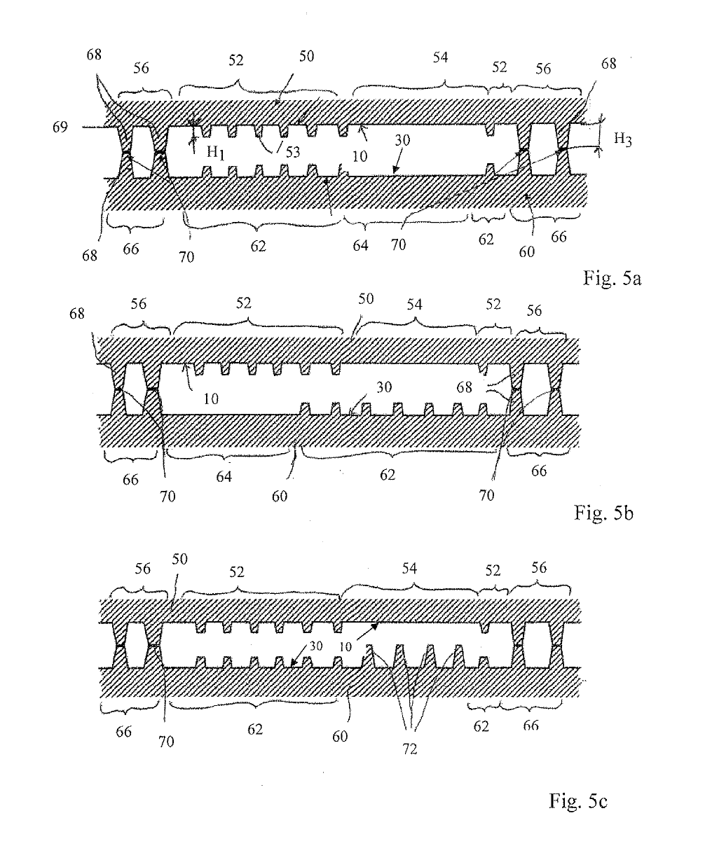

FIG. 4 shows a second embodiment of a top ply 10. Again, there is a first zone 12 with regularly arranged micro-embossing depressions forming a background pattern, second zones 16 in the shape of hearts, and third zones 18 showing angels with hearts. As can be seen from FIG. 4, some of the second zones 16a are provided separately, whereas other second zones 16b overlap with third zones 18. Further, unlike in the first embodiment as shown in FIGS. 1 to 3, the motif of the second zones 16 (hearts) is not identical to the motif element of the third zones 18 (angels with hearts). However, the motif elements thematically correspond to each other so that despite of the fact that some of the second zones might be partly overlapped by the third zones, the user still distinguishes the second zones 16 to be specific motifs of their own related to the overall motif of the embossed ply.

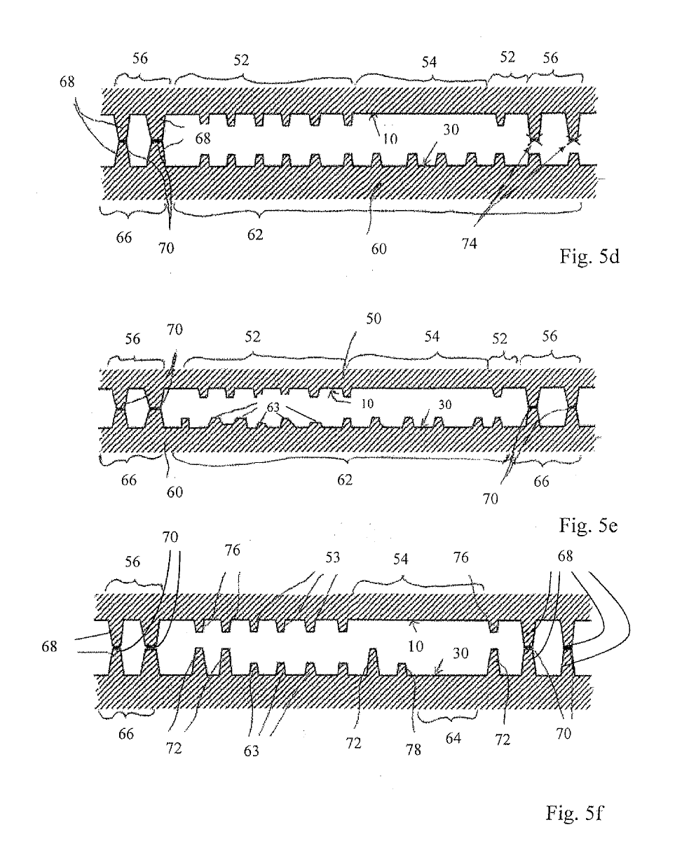

Next, different embodiments of a two-ply product produced by means of two structurized embossing rolls will be explained with regard to FIGS. 5a to 5f. All drawings show cross-sectional views through two structurized embossing rolls in order to explain the production of a two-ply product. First embossing roll 50 is used to produce the top ply 10 of the product, whereas the second embossing roll 60 produces the backside ply. For sake of simplicity, it is assumed that the top ply 10 and the bottom ply 30 fully follow the shape of the embossing protrusions on the first embossing roll 50 and the second embossing roll 60. The first embossing roll 50 has a first zone 52 with micro dots, a second zone 54 which will be referred to as a missing dots zone and a third zone 56 with lines. Correspondingly, the second embossing roll 60 is also provided with a first zone 62, a second zone 64 and a third zone 66. In the ply 10 produced, these zones 52, 54 and 56 correspond to the first zone 12, second zone 16 and third zone 18, respectively.

Between the third zones of the embossing rolls 50 and 60 with the linear protrusions in the embossing rolls, top ply 10 and bottom ply 30 are bonded together. Such ply-bonding in regions 70 can be achieved by means of glue, which can be colored.

According to the first variant of a pin-to-pin arrangement of both embossing rolls 50 and 60 according to FIG. 5a, the second embossing roll 60 is an exact mirror image of the first embossing roll 50 and both rolls are operated such that the protuberances of the third zones 56 and 66 exactly face each other so that the ply-bonding and optionally coloring can be easily carried out at these protrusions 68. Moreover, the first zones 52 and 62 as well as the second zones 54 and 64 also face each other. The linear protrusions have a height H₃ over the base circumferential surface 69 of the first embossing roll 50 which exceeds the height H₁ of the micro-embossing protrusions 53 over the base circumferential surface 69.

FIG. 5b also shows a cross-sectional view through a part of two embossing rolls and two embossed plies. The difference to FIG. 5a resides in the fact that the second embossing roll 60 is not an exact mirror of the first embossing roll 50. Nevertheless, the lines elements 68 within lines zones 56 and 66 face each other so that ply-bonding by means of adhesive can be carried out at regions 70 where the tops of the linear depressions in the first ply 10 and the second ply 30 abut each other. The missing dots zones 54 and 64 as well as the micro dots zones 52 and 62 do not face each other. Such staggered arrangement of the micro dots zones and the missing dots zones in the top ply 10 and bottom ply 30 serves to stabilize the two-ply structure because the micro-embossed depressions of one ply prevent the collapsing of the corresponding missing dots zone in the other ply.

This stabilizing effect can be even improved by using a structure as shown in FIG. 5c. In this example, the second embossing roll 60 is again not an exact mirror image of the first embossing roll 50 and only the lines elements of the first ply 10 face lines elements of the second ply 30 in order to achieve the desired ply-bonding. The micro dots zones 52 of the first embossing roll 50 faces micro dots zones 62 of the second embossing roll 60. However, the second embossing roll 60 has no missing dots zone and, corresponding to the position of the missing dots zone 54 in the first embossing roll 50, there are elevated embossing protrusions 72 in the second embossing roll 60. Such macro dots or lines 72 act to generate a support structure in the second ply which serves to stabilize, in the fibrous product the missing dots zone 16, 54 of top ply 10.

Instead of the provision of macro dots or lines 72, the embodiment according to FIG. 5c can also have micro dots on the second embossing roll 60 in a position corresponding to the missing zone 54 of the first roll. However, using macro dots or lines 72 as shown in FIG. 5c improves the desired stabilizing effect of this support structure.

According to a further variant of the pin-to-pin arrangement of two embossing rolls 50 and 60 as shown in FIG. 5d, not all third zones 56 where the first embossing roll 50 is provided with lines protrusions face a corresponding third zone in the second embossing roll 60. The linear protrusions 74 do not abut against corresponding linear protrusions in the second embossing roll so that, in the multi-ply product produced by such arrangement of the embossing rolls 50 and 60, ply-bonding will only be achieved at those third zones of the top ply, where the linear protrusions 68 of the corresponding first embossing roll 50 abut against a third zone 66 with linear protrusions 68 of the second embossing roll 60. Nevertheless, the application of glue and the optional coloring will take place toward all third zones 56 with lines elements 68 and 74 of the first embossing roll 50.

The more bonding points between top ply 10 and bottom ply 30 are provided, the stiffer the resulting product becomes. Therefore, the selective omission of bonding zones serves to adjust the resulting product to the desired softness.

A further variant of the pin-to-pin arrangement of two embossing rolls 50 and 60 is shown in FIG. 5e. This embodiment is similar to FIG. 5c and the difference lies in the fact that the micro dots zone 62 of the second embossing roll has protrusions 63 of differing heights and/or, shapes and/or, sizes and/or, flank angles and/or mutual distances. Accordingly, the micro dots of the second embossing roll 60 are not necessarily in pin-to-pin position relative to the micro dots of first roll 50.

The provision of embossing protrusions 63 of different heights, shapes, sizes, flank angles and/or relative distances makes it possible to adjust the position of the micro protrusions such as to improve the contrast to and visibility of the second zones in the product. Another option is to arrange the micro-embossing protrusions such as to provide an optically appealing effect of the micro-embossed background pattern in the second ply 30.

A further variant of the pin-to-pin arrangement of two embossing rolls 50 and 60 is shown in FIG. 5f, wherein the third zones 56 and 66 of the first embossing roll 50 and the second embossing roll 60 are arranged such that the lines elements 68 face each other and ply-bonding and optional coloring can be carried out at these elements. Further, it can be seen that some micro dots 53 of the first embossing roll 50 face micro dots 63 of the second embossing roll 60. However, other micro dots of the first embossing roll 50 like those referenced to by numeral 76 face macro dots or lines elements 72 of the second embossing roll 60. Further, the missing dots zone 54 of the first embossing roll 50 faces partly macro dots or lines element 72 on the embossing surface of the second embossing roll 60, partly micro dots 78 provided on the embossing surface of the second embossing roll 60 and partly a missing dots zone 64 of the second embossing roll 60.

The above examples of the arrangement of two structurized embossing rolls according to FIGS. 5a to 5f all relate to a pin-to-pin arrangement of two rolls so that ply-bonding was achieved between the highest elevations of the two embossing rolls corresponding to the deepest depressions in the embossed plies. The following embodiments 6a to 6c also show cross-sectional views through a part of two structurized embossing rolls and two embossed plies with the difference that the embossing rolls are operating in the nested mode.

Again, the first embossing roll 50 has a first zone 52 with micro dots, a second zone 54 with missing dots and third zones 56 with linear embossing protrusions. The second embossing roll 60 also has the corresponding first, second and third zones 62, 64 and 66. However, the first embossing roll 50 and the second embossing roll are running in register such that the second embossing roll 60 is in nested configuration to the first embossing roll 50. Therefore, different to the embodiments as shown in FIGS. 5a to 5f, adhesive applied to the first ply 10 of the product where it is positioned over the embossing protrusions of lines zones 56 of the first embossing roll 50 will bond the first ply 10 to the second ply 30 in regions 70 where the second ply 30 has no embossed depressions.

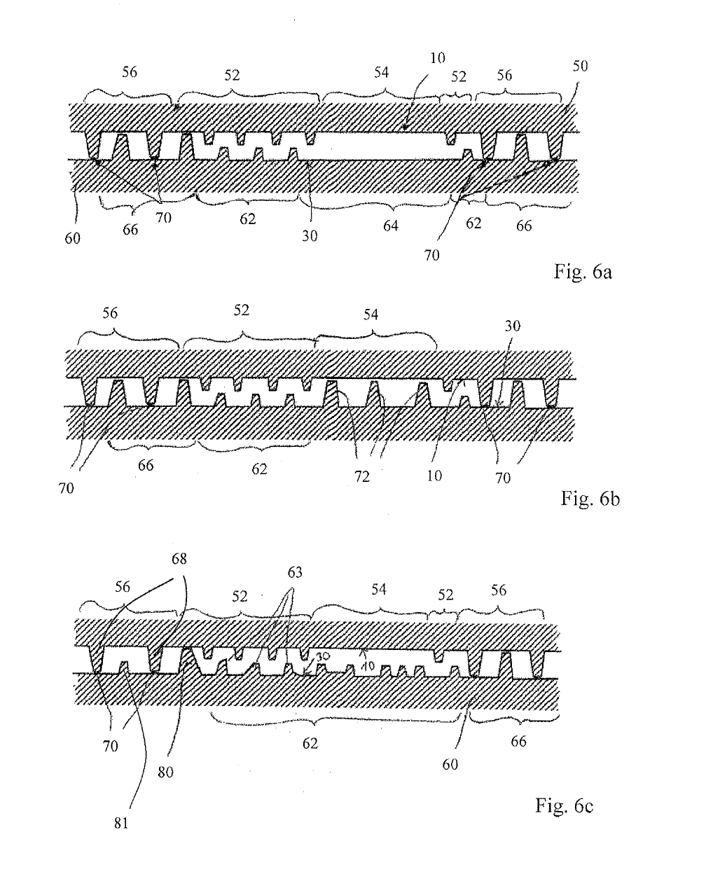

According to the variant as shown in FIG. 6a, the lines elements of the second embossing roll 60 corresponding to the linear depressions of the bottom ply 30 nest in between the line elements of the first embossing roll 50 corresponding to the linear depressions of the first ply 10. The same applies to the micro-dots of the second embossing roll 60 which are positioned between the micro-dots of the first embossing roll 50, whereas the second zones 54 and 64 with missing dots of both embossing rolls face each other.

The variant of a nested arrangement according to FIG. 6b corresponds to that according to FIG. 6a with the only difference that the missing dots zones 52 of the first embossing roll 50 faces macro dots 72 on the embossing surface of the second embossing roll 60. In this respect, the embodiment according to FIG. 6b is similar to that according to FIG. 5c as discussed above. The micro dots or lines 72 serve to produce micro depressions in the bottom ply 30 which stabilize the corresponding second zone in the top ply 10 of the multi-ply product.

The embodiment as shown in FIG. 6c is characterized in that the embossing surface of the second embossing roll 60 has no missing dots zone but an extended micro dots zone 63, wherein the micro protrusions of the embossing roll have different heights and/or, shapes and/or, sizes and/or, flank angles and/or relative distances to each other. Moreover, as can be best seen from the schematically selected shape of the macro protrusion 80 in FIG. 6c, the macro dots of the second embossing roll 60 can also be provided with different shapes, sizes, flank angles and/or relative distances to each other.

The second embossing roll 60 further includes a single micro dot 81 positioned between the line elements 68 of the first embossing roll 50.

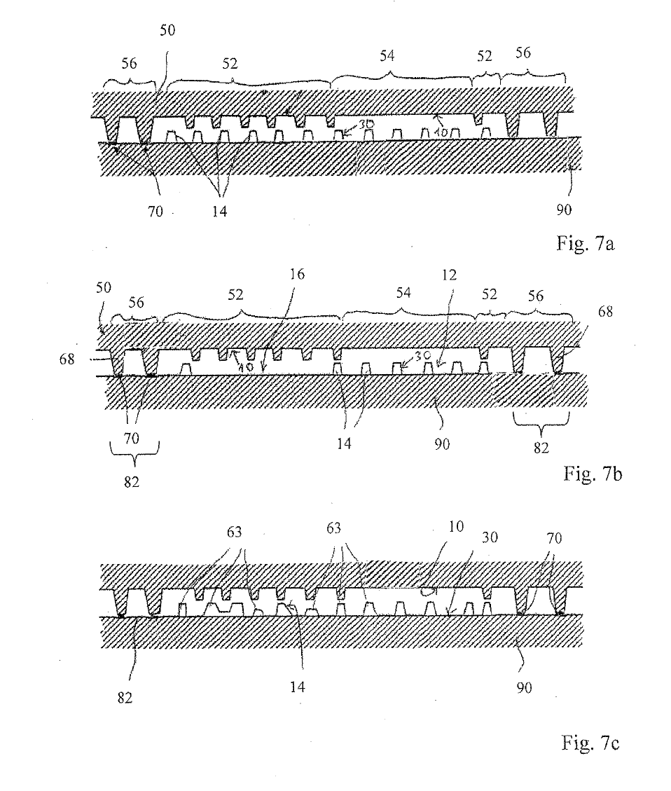

FIGS. 7a to 7c show cross-sectional views of the structurized embossing roll 50 and a marrying roll 90 as used in the conventional Goffra Incolla technique. Embossing roll 50 is the same as that e.g. shown in FIG. 5a or 6a with micro dot zones 52, missing dot zones 54 and lines zones 56. As in the preceding embodiments, the embossing protrusions in the lines zones 56 have a larger height than the micro-embossing protrusions in the first zones 52. Therefore, glue applied to the highest protrusions of the top ply arranged over the first embossing roll 50 will only receive adhesive in regions 70 corresponding to the highest elevations of the first embossing roll 50 which generate the deepest embossing depressions of the top ply 10. A second embossing roll is not shown in FIG. 7a but only the marrying roll 90 having a flat surface. Nevertheless, second ply 30 was embossed in a preceding method step why the second ply 30 has micro-embossing depressions 14 on its surface.

According to the variant as shown in FIG. 7a, the micro-embossed second ply 30 is flattened by the marrying roll in those regions 70 of the second ply where first ply 10 and second ply 30 are bonded together. The first zones of the first ply produced by the micro-dots zones 52 of embossing roll 50 face micro-dots 14 of second ply 30, and unembossed second zones of the first ply also face micro-embossed depressions 14 of the second ply 30. In absence of any linear depressions of the second ply 30, there is no pin-to-pin or nested configuration of linear depressions of the first and second plies.

According to a second variant as shown in FIG. 7b, the second ply 30 may be provided with three zones including a first zone 12 with micro-embossed depressions, a second zone 16 which is unembossed as well as flattened zones 82 where line elements 68 of the first embossing roll 50 flatten the second ply 30 during the marrying process.

An alternative embodiment as shown in FIG. 7c mainly corresponds to that according to FIG. 7a with the difference that within the first zone 12 of the second ply 30, the individual micro-embossed depressions 63 have different heights and/or shapes and/or sizes and/or flank angles and/or relative distances to each other. The micro-embossed depressions 63 of the second ply 30 are not necessarily in a pin-to-pin or nested position relative to the first ply 10.

In the above description of detailed embodiments, embossing rolls have been described which have embossing protrusions of different heights. However, it should be noted that these embodiments are only one possible example to work the invention. It is also possible to use two subsequent embossing stations wherein the micro-embossed depressions of the first ply 10 are produced first, followed by a second embossing station in which the linear embossing depressions, the application of glue, and the ply-bonding are carried out.

The fibrous product as described in detail above has an improved softness. Experiments have shown that samples having the three different zones 52, 54, 56 as described above have a high hand-feel value. Both the top ply and the bottom ply can include more than one layer and, in order to impart high volume to the product, a volume embossed middle layer can be provided. In order to improve the optical appearance of the product, one or more plies of the product can be colored.

1. A fibrous product comprising:
at least one ply, the surface of which is partly covered with an embossing pattern;
at least one first continuous zone being micro-embossed with at least 25 embossing depressions per cm² forming a background embossing area;
a plurality of second zones being unembossed and forming at least one motif element; and
at least one third zone being largely surrounded by linear depressions.

2. The fibrous product according to claim 1, wherein the second zone abuts the first zone.

3. The fibrous product according to claim 1, wherein all third zones and all second zones are arranged such that the second zones and third zones are isolated from each other.

4. The fibrous product according to claim 1, wherein at least one second zone and at least one third zone are arranged such that they overlap with each other.

5. The fibrous product according to claim 1, wherein at least one second zone has a size of at least 0.5 cm²; and
wherein the at least one third zone has a size of at least 0.2 cm².

6. The fibrous product according to claim 1, wherein the total area of all first zones covers 25% to 90% of the total surface area of a side of the product;
wherein the total area of all second zones covers 5% to 70% of the total surface area of the side of the product; and
wherein the total area of all third zones covers 5% to 30% of the total surface area of the side of the product.

7. The fibrous product according to claim 1, wherein the product comprises at least two plies bonded together,
wherein ply-bonding is effected by adhesive; and
wherein the ply-bonding is effected along at least some of the linear depressions of the at least one third zone.

8. The fibrous product according to claim 1, wherein each ply has a basis weight of 10 to 40 g/m² or the fibrous product has a total basis weight of 15 to 120 g/m².

9. The fibrous product according to claim 1, wherein the fibrous product is made of creped tissue paper.

10. The fibrous product according to claim 1, wherein the caliper per ply is at least 100 μm.

11. An embossing roll for producing a fibrous product having an embossing surface with protrusions suitable to run against an anvil roll, wherein the embossing surface comprises:
at least one first zone being a micro-embossing zone with at least 25 micro-embossing protrusions per cm², the micro-embossing protrusions having a first height over a base circumferential surface of the embossing roll;
a plurality of second zones with no embossing protrusions within the second zones, the second zones having a second height over the base circumferential surface of the embossing roll; and
a plurality of third zones being provided by continuous or interrupted linear protrusions and having a third height over the base circumferential surface of the embossing roll.

12. The embossing roll according to claim 11, wherein the first height is between 0.4 mm and 1.4 mm; the second height is between 0 mm and 2.5 mm; and the third height is between 0.8 mm and 2.5 mm.

13. An embossing device for manufacturing a fibrous product, comprising at least one embossing roll according to claim 11 and at least one anvil roll.

14. An embossing device for manufacturing a fibrous product, comprising a first embossing roll and a second embossing roll arranged downstream of the first embossing roll, wherein the first embossing roll has a circumferential embossing surface and at least one first zone on the circumferential embossing surface of the first embossing roll which is provided with micro-embossing protrusions having a density of at least 25 micro-embossing protrusions per cm², and a plurality of further zones with no embossing protrusions and
wherein the second embossing roll has a circumferential embossing surface and a plurality of third zones on the circumferential embossing surface of the second embossing roll being provided mainly with linear protrusions.

15. The embossing device according to claim 13, further comprising a marrying roll.

16. The embossing device according to claim 13, further comprising an application roll for applying adhesives.

17. A method of making a fibrous product according to claim 1, comprising the steps of:
(a) embossing the at least one first zone; and
(b) embossing the at least one third zone,
wherein steps (a) and (b) are carried out simultaneously by directing at least one ply into the nip between an embossing roll and a counter roll, or sequentially by directing the at least one ply through at least two subsequent embossing devices.

18. The method according to claim 17, further comprising the step of:
(c) calendering the second zones in step (a) or in step (b).

19. The method according to claim 17, further comprising the step of:
(d) laminating the at least one ply and a further ply at least at some of the line elements of the third zones by applying adhesive to at least some of the line elements of the third zones.

20. A method of making the fibrous product according to claim 1, comprising structuring at least one ply in at least one manufacturing zone directly within the tissue making process under wet conditions, wherein an element used in the structuring step is selected from the group consisting of a structurized fabric, a belt, and a felt.
